(19) United States
(12) Patent Application Publication
(10) Pub. No.: US 2026/0044837 A1
(43) Pub. Date: Feb. 12, 2026

(54) ELECTRONIC DEVICE SUBSCRIPTION PURCHASE GENERATION BASED ON PATTERN OF PAST OFFLINE PURCHASES

(71) Applicant: MOTOROLA MOBILITY LLC, WILMINGTON, DE (US)

(72) Inventors: KRISHNAN RAGHAVAN, BANGALORE (IN); VIJAYPRAKASH IDLUR, IDLUR (IN); PRASAD A G, BANGALORE (IN)

(21) Appl. No.: 18/798,645

(22) Filed: Aug. 8, 2024

(51) Int. Cl. G06Q 20/04; G06Q 30/0601

(52) U.S. Cl. CPC G06Q 20/047; G06Q 30/0631

(57) ABSTRACT

An electronic system, a method and a computer program implement processes for generating product or service subscription offers based on analyzing offline payment and financial transactions data for a user. A controller is configured to cause an electronic device of the electronic system to analyze multiple point of sale (POS) purchase receipts to identify a purchase item(s) including a first product. The controller identifies availability of the first product via an ecommerce service. The controller determines a purchase frequency of the first product. The controller renders a purchase interface indicating a subscription offer for the first product and modifies, via output device(s), a display to contain and present the purchase interface.

### BACKGROUND

### 1. Technical Field

The present disclosure relates generally to electronic devices having a display for presenting a user interface, and more particularly to electronic devices having a display that presents a user interface for browsing and purchasing goods and services.

### 2. Description of the Related Art

As technology has advanced, uses for electronic devices have expanded to include ecommerce purchases. A large number of products are available for purchase and delivery. Ecommerce services have created searchable inventories of these products for review via electronic devices such as desktop computers, laptops, notebooks, and smartphones. Hierarchical organization of products and flexible querying features generally enable users to find the products that they want. Ecommerce and banking applications enable users to purchase the products and to track the electronic payment and financial transaction data. However, many payments and financial transactions for goods and services continue to be done in person rather than online, resulting in paper receipts and other transaction records. Recently “super applications” are being introduced that, in addition to providing ecommerce and banking services, analyze the paper receipts for incorporating with other electronic data.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram of an electronic device in which the features of the present disclosure are advantageously implemented for generating product or service subscription offers based on analyzing offline payment and financial transactions data, according to one or more embodiments;

FIG. 2 is a communication diagram of an example subscription opportunity identification engine of the communication device of FIG. 1 implemented to analyze offline transactions data and generate the subscription offers, according to one or more embodiments;

FIG. 3 is a front view of a display of the communication device presenting an individualized payment and financial transaction processing (IPFTP) interface window to analyze offline receipts, according to one or more embodiments;

FIG. 4 is an interface section of the IPFTP interface window of FIG. 3 presenting a product or service subscription offer, according to one or more embodiments; and FIG. 5A-5B (collectively “FIG. 5”) presents a flow diagram illustration of a computer-implemented method for generating product or service subscription offers based on analyzing offline payment and financial transactions data, according to one or more embodiments.

### DETAILED DESCRIPTION

According to aspects of the present disclosure, an electronic system, a method and a computer program product implement processes for generating product or service subscription offers based on analyzing offline payment and financial transactions data for a user. In one or more embodiments, the electronic system includes a memory, at least one electronic device having at least one input device, at least one output device, a communications subsystem, and a controller. The controller is communicatively coupled to the memory, the at least one input device, the at least one output device, and the communications subsystem. The controller is configured to cause the at least one electronic device to analyze two or more point of sale (POS) purchase receipts to identify a purchase of one or more items, including a first product/service. The controller is configured to cause the at least one electronic device to identify availability of the first product/service via an ecommerce service. The controller is configured to cause the at least one electronic device to determine a purchase frequency of the first product. The controller is configured to cause the at least one electronic device to render a purchase interface indicating a subscription offer for the first product. When and if the subscription offer is accepted, the controller is configured to cause the at least one electronic device to modify, via the at least one output device, a display to contain the purchase interface.

The global banking sector is undergoing disruption as digital players enter the market with “money management” tools. An example is “Spend Insights” that collects transaction information (e.g., category, notes, receipts) and tags the transaction information to help users understand their spending habits better. The tagging may be automatic or customer driven. In an example, users will be able to tag and manage their spending by categorizing transactions, adding images or receipts, adding personalized notes, and using customizable tags for sub-categories or spending purposes.

According to aspects of the present disclosure, bringing paper payment and financial transaction records into an electronic form creates an opportunity for an ecommerce future transaction. The subscription orders market in e-commerce involves customers signing up for regular, often recurring deliveries of products. The subscription order market offers numerous benefits to both users and businesses. For users, subscription orders bring convenience by ensuring a steady supply of essential products without the hassle of reordering each time. This convenience is particularly valuable for items like groceries, toiletries, and pet supplies. Moreover, subscribers often enjoy cost savings through bulk purchases or exclusive discounts. Businesses also benefit from the predictable revenue stream that subscriptions provide. Subscriptions help in better inventory management and foster customer loyalty.

In one or more embodiments, the present disclosure may implement the subscription offer generation within a “super app” that includes “mini apps” for analyzing paper records and for ecommerce purchases. A super-app is a mobile or web application that can provide multiple services including payment and financial transaction processing, effectively becoming an all-encompassing self-contained commerce and communication online platform that embraces many aspects of personal and commercial life. For end users, a super app is an application that provides a set of core features while also giving access to independently developed mini apps. By installing a single app, users can access the increased functionality of the super app with login and data shared across the super app and the mini apps. In an example, a super app may support a shopping service, a digital bank, a content app with news, videos, games and podcasts. For the sponsor of the super app, user traffic that comes into one application is leveraged to drive users into using the other services. The services share a common identifier, data, look and feel, etc. Hence, the super app provides a cohesive, personalized experience across all of the mini apps. Super apps provide additional opportunities to build a connected experience across diverse services.

For clarity, illustrations herein depict tangible goods, products or merchandise. However, aspects of the present disclosure do encompass procuring periodic services. In an example, a user may regularly pay offline for a mobile dog groomer, a lawn mowing service, a dog walking service, etc. Purchase frequency for a product or service may be determined by identifying more than one purchase for the product or service during a period of time (e.g., week, month, calendar quarter, year). The quantity total for products all of the purchases is determined. In an example, in certain instances, the user buys two cartons of a product. In another instance the user buys three cartons. The purchase frequency is based on individual units of the product. The period of time is divided by the number of units purchased during the period of time for the purchase frequency. To account for products that are perishable and may have storage size implications, the purchase frequency may further group subscriptions to a number of units per delivery that do not exceed the number of units purchased offline at one time.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements can be provided with similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

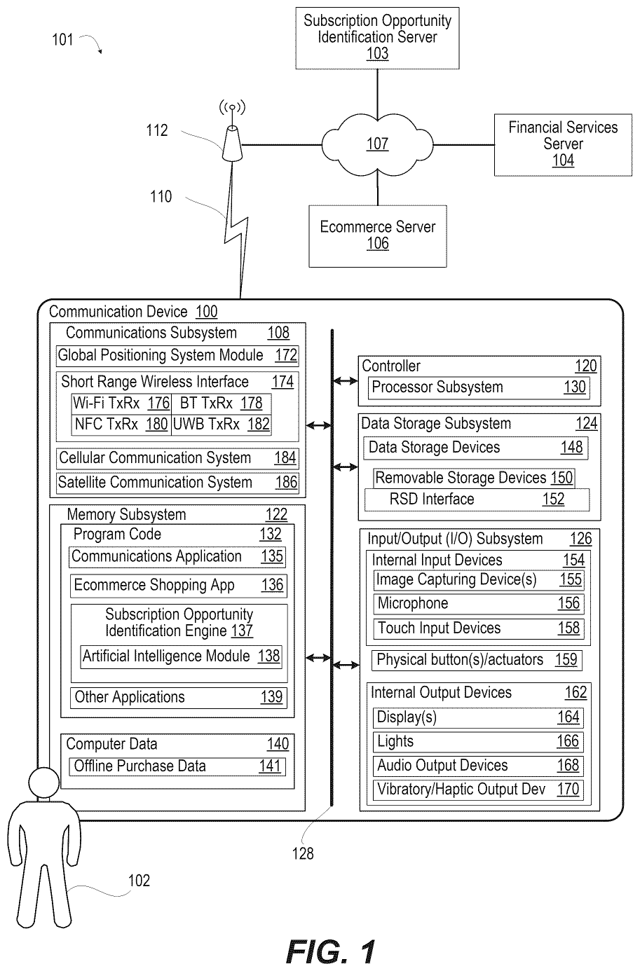

FIG. 1 presents a simplified functional block diagram of an electronic device in which the features of the present disclosure are advantageously implemented for generating product or service subscription offers based on analyzing offline payment and financial transactions data. In one or more embodiments, the electronic device includes additional communications functionality that enables electronic device to be referred to as communication device 100, which operates as a mobile user device for user 102 in communication environment 101. Aspects of the present disclosure may be implemented at least in part in subscription opportunity identification server(s) 103 that includes some or all of the components and functionality described herein. In the specific example of FIG. 1, communication environment 101 includes one or more financial services server 104 and ecommerce server 106, which are accessible to communication device 100 through communication network 107. Communications device 100 includes communications subsystem 108 that connects via wired or wireless channel 110 to node 112 (e.g., wireless access point, cellular tower) to communicatively connect to financial services server 104 and ecommerce server 106 via one or more communication network 107.

Communication device 100 can be one of a host of different types of devices, including but not limited to, a mobile cellular phone, satellite phone, or smart phone, a laptop, a netbook, an ultra-book, a networked smartwatch, or networked sports/exercise watch, and/or a tablet computing device or similar device that can include wireless communication functionality. As a device supporting wireless communication, communication device 100 can be utilized as, and also be referred to as, a system, device, subscriber unit, subscriber station, mobile station (MS), mobile, mobile device, remote station, remote terminal, user terminal, terminal, user agent, user device, a session initiation protocol (SIP) phone, a wireless local loop (WLL) station, a personal digital assistant (PDA), computer workstation, a handheld device having wireless connection capability, a computing device, or other processing devices. User 102 may use one or more second electronic devices similar or identical to communication device 100 with preferences shared across devices.

In addition to communications subsystem 108 and controller 120, communication device 100 may include memory subsystem 122, data storage subsystem 124 and input/output (I/O) subsystem 126. To enable management by controller 120, system interlink 128 communicatively connects controller 120 with communications subsystem 108, memory subsystem 122, data storage subsystem 124 and I/O subsystem 126. System interlink 128 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 128) are illustrated in FIG. 1, it is to be understood that more, fewer, or different interconnections may be present in other embodiments.

Controller 120 includes processor subsystem 130, which includes one or more central processing units (CPUs) or data processors. Processor subsystem 130 can include one or more digital signal processors (DSP) graphics processing units (GPUs), image capture device (ICD) controller, and hardware acceleration (HA) unit, etc. that can be integrated with data processor(s). Processor subsystem 130 can, in some embodiments, include image signal processors (ISPs) (not shown) and dedicated artificial intelligence (AI) engines. In one or more embodiments, processor subsystem 130 can execute AI modules to provide AI functionality of AI engines. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor subsystem 130 can interchangeably be referred to as controller 120. For simplicity in describing the features of communication device 100, the functionality provided by one or more of CPU, DSP, GPU, ISP/ICD controller, etc. are collectively described as being performed by processor subsystem 130 (or controller 120). Collectively, components integrated within processor subsystem 130 support computing, classifying, processing, transmitting and receiving of data and information, and presenting of graphical images within a display, etc.

Processor subsystem 130 can include other processors such as auxiliary processor(s) that may act as a low power consumption, always-on sensor hub for physical sensors. Controller 120 manages, and in some instances directly controls, the various functions and/or operations of communication device 100. These functions and/or operations include, but are not limited to including, application data processing, communication, navigation tasks, image processing, and signal processing. In one or more alternate embodiments, communication device 100 may use hardware component equivalents for application data processing and signal processing. For example, communication device 100 may use special purpose hardware, dedicated processors, general purpose computers, microprocessor-based computers, micro-controllers, optical computers, analog computers, dedicated processors and/or dedicated hard-wired logic.

Memory subsystem 122 stores program code 132 for execution by processor subsystem 130 to provide the functionality described herein. Program code 132 includes applications such as communications application 135, ecommerce shopping application 136, subscription opportunity identification engine 137, which may include artificial intelligence (AI) module 138, and other applications 139.

In one or more embodiments, several of the described aspects of the present disclosure are provided via executable program code of applications executed by controller 120. In one or more embodiments, program code 132 may be integrated into a distinct chipset or hardware module as firmware that operates separately from executable program code. Portions of program code 132 may be incorporated into different hardware components that operate in a distributed or collaborative manner. Memory subsystem 122 further includes operating system (OS), firmware interface, such as basic input/output system (BIOS) or Uniform Extensible Firmware Interface (UEFI), and firmware, which also includes and may thus be considered as program code 132.

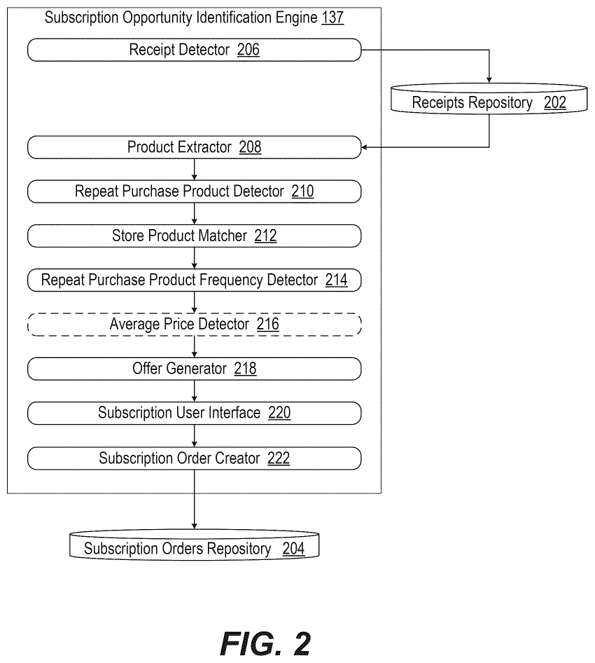

Program code 132 may access, use, generate, modify, store, or communicate computer data 140, such as offline purchase data 141 that is analyzed by subscription opportunity identification engine 137. An example implementation of subscription opportunity identification engine 137 is described below with regard to FIG. 2. With continued reference to FIG. 1, computer data 140 may incorporate “data” that originated as raw, real-world “analog” information that consists of basic facts and figures. Computer data 140 includes different forms of data, such as numerical data, images, coding, notes, and financial data. Computer data 140 may originate at communication device 100 or be retrieved from a remote device via communications subsystem 108. Communication device 100 may store, modify, present, or transmit computer data 140, such as offline purchase data 141. Computer data 140 may be organized in one of a number of different data structures. Common examples of computer data 140 include video, graphics, text, and images. Computer data 140 can also be in other forms of flat files, databases, and other data structures.

Data storage subsystem 124 of communication device 100 includes data storage device(s) 148. Controller 120 is communicatively connected, via system interlink 128, to data storage device(s) 148. Data storage subsystem 124 provides program code 132 and computer data 140 stored on nonvolatile storage that is accessible by controller 120. For example, data storage subsystem 124 can provide a selection of program code 132 and computer data 140. These applications can be loaded into memory subsystem 122 for execution/processing by controller 120. In one or more embodiments, data storage device(s) 148 can include hard disk drives (HDDs), optical disk drives, and/or solid-state drives (SSDs), etc. Data storage subsystem 124 of communication device 100 can include removable storage device(s) (RSD(s)) 150, which is received in RSD interface 152. Controller 120 is communicatively connected to RSD 150, via system interlink 128 and RSD interface 152. In one or more embodiments, RSD 150 is a non-transitory computer program product or computer readable storage device that stores program code and/or instructions that may be executed by a processor associated with a user device such as communication device 100. Controller 120 can access data storage device(s) 148 or RSD 150 to provision communication device 100 with program code 132 and computer data 140.

I/O subsystem 126 may include internal input devices 154 such as image capturing device(s) 155, microphone 156, and touch input devices 158 (e.g., screens, keys, or buttons). I/O subsystem 126 may include physical buttons/actuators 159 that can be located on a periphery of the device housing. I/O subsystem 126 may include internal output devices 162 such as display(s) 164, lights 166, audio output devices 168, and vibratory or haptic output devices 170.

In one or more embodiments, controller 120, via communications subsystem 108, performs multiple types of cellular over-the-air (OTA) connections. In one or more embodiments, controller 120, via communications subsystem 108, may communicate via an OTA cellular connection with radio access networks (RANs). In an example, communication device 100, via communications subsystem 108, connects via RANs of a terrestrial network that is communicatively connected to a network server. In one or more embodiments, controller 120, via communications subsystem 108, communicates via a wireless local area network (WLAN) link using one or more IEEE 802.11 WLAN protocols with an access point. In one or more embodiments, controller 120, via communications subsystem 108, performs other types of wireless communication, such as by using a Bluetooth connection or other personal access network (PAN) connection. In an example, a user may wear a health monitoring device such as a smartwatch that is communicatively coupled to communication device 100 via a wireless connection. In one or more embodiments, communications subsystem 108 includes global positioning system (GPS) module 172 that receives GPS broadcasts from GPS satellites to obtain geospatial location information, which enables communication device 100 to self-locate, among other features. In one or more embodiments, communications subsystem 108 includes integrated short range wireless interface chipset 174 having Wi-Fi component 176, Bluetooth (BT) transceiver (TxRx) 178, near field communication (NFC) TxRx 180, and ultra-wideband (UWB) TxRx 182. In one or more embodiments, communications subsystem 108 further includes long distance communication capabilities including cellular communication system 184 and satellite communication system 186.

In one or more embodiments, subscription opportunity identification engine 137 includes artificial intelligence (AI) module 138 that is trained to recognize identification of particular goods or services in content of images. In an example, particular retailers may use different abbreviations or codes for a brand of a product. An ecommerce retailer may use different terms and codes for a similar or identical brand. Subscription opportunity identification engine 137 and AI module 138 may be stored in memory subsystem 122 of communication device 100 and executed by controller 120 to perform various aspects of the functionality of the present disclosure. Training of AI module 138 is the process by which AI models are trained to perform specific tasks or achieve certain objectives. The training involves providing the model with a large amount of data and allowing the model to learn from patterns and relationships within that data. Controller 120 may include various functionalities that enable controller 120 to perform different aspects of AI models. AI models may include an artificial neural network, a decision tree, a support vector machine, Hidden Markov model, linear regression, logistic regression, Bayesian networks, and so forth. The AI models can be individually trained to perform specific tasks and can be arranged in different sets of AI models to generate different types of output.

According to aspects of the present disclosure, controller 120 is configured to cause communication device 100 to analyze received images of two or more point of sale (POS) purchase receipts to identify a purchase of one or more items, including a first product. Controller 120 is configured to cause communication device 100 to identify availability of the first product via ecommerce service server 106. Controller 120 is configured to cause communication device 100 to determine a purchase frequency of the first product. Controller 120 is configured to cause communication device 100 to render a purchase interface indicating a subscription offer for the first product. Controller 120 is configured to cause communication device 100 to modify, via the at least one output device, a display to contain the purchase interface.

In one or more embodiments, controller 120 is configured to cause communication device 100 to identify, from analyzing the two or more POS purchase receipts, a respective quantity and dates of purchases of the first product. Controller 120 is configured to cause communication device 100 to determine a consumption rate of the first product based on the respective quantity and dates of purchases. Controller 120 is configured to cause communication device 100 to determine a subscription quantity and purchase frequency to match the consumption rate.

In one or more embodiments, controller 120 is configured to cause communication device 100 to analyze the two or more POS purchase receipts to identify an average purchase price of the first product. Controller 120 is configured to cause communication device 100 to determine a subscription price that is less than the average purchase price of the first product indicated in the two or more POS purchase receipts. Controller 120 is configured to cause communication device 100 to present the subscription price with the subscription offer.

In one or more embodiments, controller 120 is configured to cause communication device 100 to allocate one or more cost adjustment contained in the two or more POS purchase receipts in identifying the respective purchase price. Controller 120 is configured to cause communication device 100 to determine the subscription price that includes the one or more cost adjustment. In one or more particular embodiments, the one or more cost adjustment includes one or more expenses from among: (i) a sales tax; (ii) a shipping charge; (iii) a handling charge; (iv) an insurance fee; (v) a use fee; (vi) a government fee; (vii) a delivery charge; (viii) a discount; and (ix) a coupon.

In one or more embodiments, controller 120 is configured to cause communication device 100 to search for matching subscription offers for the first product in more than one ecommerce service. Controller 120 is configured to cause communication device 100 to determine the subscription price based on identifying at least one of the matching subscription offers that is less than the average purchase price indicated in the two or more POS purchase receipts.

In one or more embodiments, controller 120 is configured to cause communication device 100 to receive one or more images containing the two or more purchase receipts. Controller 120 is configured to cause communication device 100 to perform optical character recognition to enable analyzing of the two or more POS purchase receipts to identify the purchased one or more products and the associated prices.

In one or more embodiments, in response to identifying unavailability of the first product for purchase via an ecommerce service, controller 120 is configured to cause communication device 100 to identify availability of a second product that is a substitute for the first product. Controller 120 is configured to cause communication device 100 to present, via the at least one output device, the purchase interface indicating a subscription offer for the second product. In one or more embodiments, in response to a user input indicating acceptance of the subscription offer, controller 120 is configured to cause communication device 100 to create and store a subscription order for the second product in accordance with the subscription offer that triggers delivery at subscription delivery date.

FIG. 2 is a communication diagram of example modules of subscription opportunity identification engine 137 of the communication device of FIG. 1, implemented to analyze the payment and financial transaction data in receipts repository 202 and to communicate subscription orders to subscription orders repository 204. In one or more embodiments, receipt detector 206 detects and segregates receipts or similar transaction documents from one or more documents. In an example, receipt detector 206 uses image-to-text conversion algorithm(s) to detect the receipts in content of imaged documents. Receipt detector 206 may include recognizing a format of a receipt and detecting a seller based on recognizing a store name or code such as a tax identifier. Receipt detector 206 stores the segregated receipts in receipts repository 202. In an example, receipts repository 202 supports all receipts for purchases from offline stores in a format that supports queries. Product extractor 208 is communicatively coupled to receipts repository 202 to extract or find exact details of products purchased offline based on the queried receipts. In an example, product extractor 208 uses seller information in the receipts to access data for expanding any abbreviated product information into robust product information. Repeat purchase product detector 210 identifies when a same product has been purchased in two or more receipts over a recent time period. Store product matcher 212 uses a stock keeping unit (SKU) number or other identifying product information for each recent repeat purchase products to match the product(s) that are available from one or more ecommerce services. Availability may include determining delivery location limits for the respective ecommerce service. In an example, perishable products may have a limited geographic delivery area. Repeat purchase product frequency detector 214 then identifies the periodicity of the purchase in the recent time period for the products that are identified by repeat purchase product detector 210 and that have at least one match identified by store product matcher 212. In one or more embodiments, for the matched repeat purchases, average price detector 216 identifies average price paid by the consumer for that product at the offline stores. Given the convenience provided by the subscription, being able to provide a lower price of purchase, delivery, etc., may or may not be required. Offer generator 218 submits the predicted purchase volume to one or more sellers (e.g., ecommerce services) to prompt receiving back one or more subscription offers. Particular sellers may lower the price to at least match competitors. In one or more embodiments, offer generator 218 includes the current price being paid by the consumer to the seller to solicit a better price offer for the same product. Subscription user interface 220 receives any subscription offer(s). The subscription offers may include unit pricing, pricing for buying a larger number of units during one delivery, pricing for a guaranteed number of deliveries, costs associated with shipping, handling, government-imposed fees, or other expenses. In one or more embodiments, subscription user interface 220 compares the subscription price against the current price being paid and presents this information. In an example, the comparison information is only provided if favorable to accepting the subscription offer. Subscription order creator 222 responds to a user input to subscription user interface 220 indicating acceptance of the subscription offer by generating a subscription order with the quantity and periodicity determined for the previous offline purchases. Subscription user interface 220 communicates the subscription order to subscription orders repository 204 to trigger implementation of the subscription.

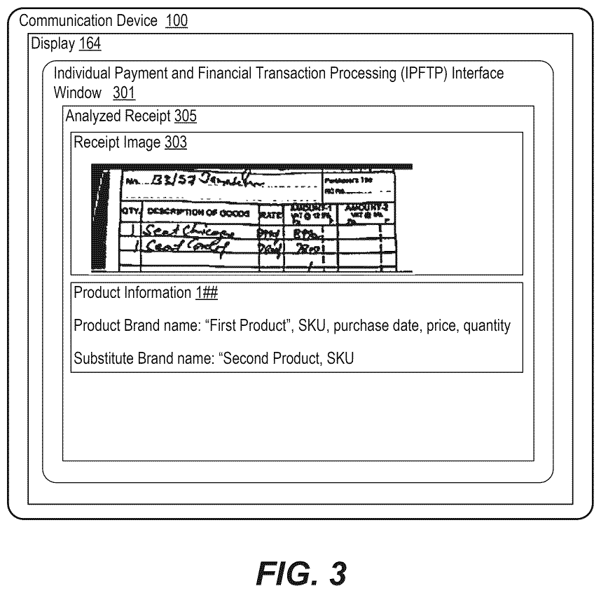

FIG. 3 is a front view of display 164 of communication device 100 presenting an individualized payment and financial transaction processing (IPFTP) window 301 to analyze and display offline receipts, such as receipt image 303. Analyzed receipt interface section 305 may further include robust purchase and product information detected within the receipt or accessed based on content of receipt image 303

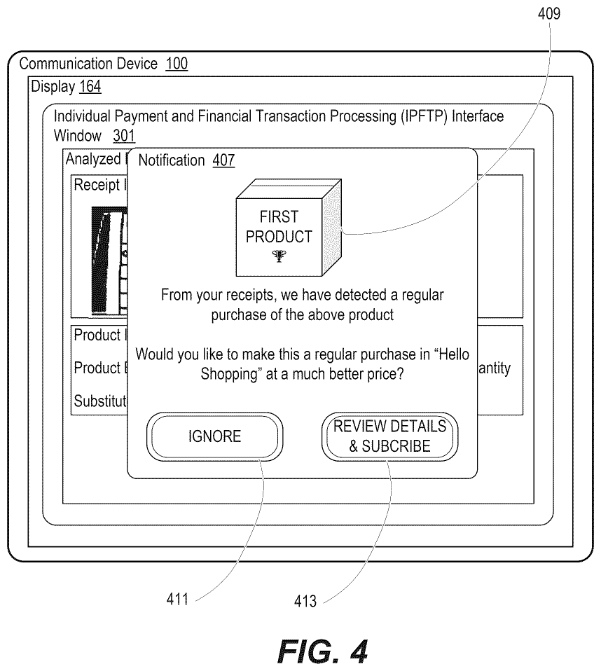

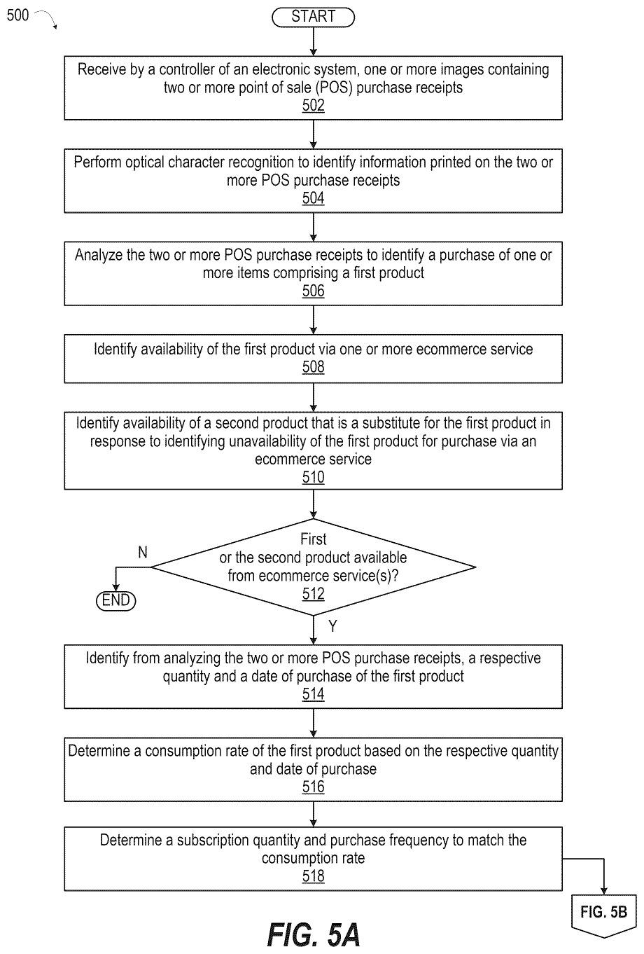

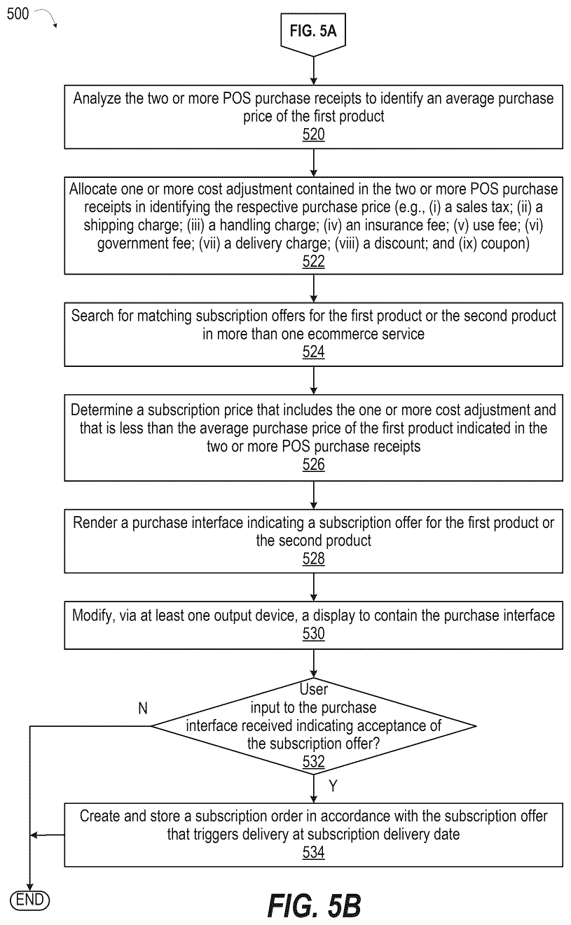

FIG. 4 is an interface section of the IPFTP window of FIG. 3 presenting a product or service subscription offer within notification interface box 407. In an example, subscription offer includes product image 409 and a message such as “from your receipts, we have detected a regular purchase of the above product. Would you like to make this a regular purchase in “Hello Shopping” at a much better price? ” Notification interface box 407 also includes ignore control 411 to reject the subscription offer and “review details and subscribe” control 413 to trigger navigation to a subscription portal.

FIG. 5A-5B (collectively “FIG. 5”) presents a flow diagram illustration of method 500 for generating product or service subscription offers based on analyzing offline payment and financial transactions data. The description of method 500 is provided with general reference to the specific components illustrated within the preceding FIG. 1-4. Specific components referenced in method 500 (FIG. 5) may be identical or similar to components of the same name used in describing preceding FIG. 1-4. In one or more embodiments, controller 120 (FIG. 1) configures communication device 100 (FIG. 1) or a similar computing device to provide the described functionality of method 500 (FIG. 5). With reference to FIG. 5A, method 500 includes receiving, by a controller of an electronic system, one or more images containing two or more point of sale (POS) purchase receipts (block 502). Method 500 includes performing optical character recognition to identify information printed on the two or more POS purchase receipts (block 504). Method 500 includes analyzing the two or more POS purchase receipts to identify a history of purchase of one or more items, including a first product (block 506). Method 500 includes identifying availability of the first product via one or more ecommerce service (block 508). Method 500 includes identifying availability of a second product that is a substitute for the first product in response to identifying unavailability of the first product for purchase via an ecommerce service (block 510). Method 500 includes determining whether the first product or the second product is available from the one or more ecommerce service (decision block 512). In response to determining that the first product or the second product is not available from the one or more ecommerce service, method 500 ends. In response to determining that the first product or the second product is available from the one or more ecommerce service, method 500 includes identifying, from analyzing the two or more POS purchase receipts, a respective quantity and a date of purchase of the first product (block 514). Method 500 includes determining a consumption rate of the first product based on the respective quantity and date of purchase (block 516). Method 500 includes determining a subscription quantity and purchase frequency to match the consumption rate (block 518). Then method 500 proceeds to block 520 of FIG. 5B.

With reference to FIG. 5B, method 500 includes analyzing the two or more POS purchase receipts to identify an average purchase price of the first product (block 520). Method 500 includes allocating one or more cost adjustment contained in the two or more POS purchase receipts in identifying the respective purchase price (e.g., (i) a sales tax; (ii) a shipping charge; (iii) a handling charge; (iv) an insurance fee; (v) a use fee; (vi) a government fee; (vii) a delivery charge; (viii) a discount; and (ix) a coupon) (block 522). Method 500 includes searching for matching subscription offers for the first product or the second product in more than one ecommerce service (block 524). Method 500 includes determining a subscription price that includes the one or more cost adjustment and that can be less than the average purchase price of the first product indicated in the two or more POS purchase receipts (block 526). Method 500 includes rendering a purchase interface indicating a subscription offer for the first product/service or the second product/service (block 528). Method 500 includes modifying, via at least one output device, a display to contain the purchase interface (block 530). Method 500 includes determining whether a user input to the purchase interface is received indicating acceptance of the subscription offer (decision block 532). In response to receiving the user input indicating acceptance of the subscription offer, method 500 includes creating and storing a subscription order in accordance with the subscription offer that triggers delivery at subscription delivery date (block 534). In response to not receiving the user input indicating acceptance of the subscription offer in decision block 532 or after creating and storing the subscription order in block 534, method 500 ends.

According to aspects of the present disclosure, communication device 100 (FIG. 1), methods 500 (FIG. 5), and computer program product, such as RSD 150 (FIG. 1), implement processes for generating product or service subscription offers based on analyzing offline payment and financial transactions data for a user. For users, subscription orders bring convenience by ensuring a steady supply of essential products without the hassle of reordering each time. This convenience is particularly valuable for items like groceries, toiletries, and pet supplies. Moreover, subscribers often enjoy cost savings through bulk purchases or exclusive discounts. Businesses also benefit from the predictable revenue stream that subscriptions provide. Subscriptions help in better inventory management and foster customer loyalty.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic system comprising:
at least one electronic device comprising:
at least one input device;
at least one output device;
a communications subsystem; and
a controller communicatively coupled to the at least one input device, the at least one output device, and the communications subsystem, and which is configured to cause the at least one electronic device to:
analyze two or more point of sale (POS) purchase receipts to identify a purchase of one or more items comprising a first product;
identify availability of the first product via an ecommerce service;
determine a purchase frequency of the first product;
render a purchase interface indicating a subscription offer for the first product; and
modify, via the at least one output device, a display to contain the purchase interface.

2. The electronic system of claim 1, wherein the controller is configured to cause the at least one electronic device to:
identify from analyzing the two or more POS purchase receipts, a respective quantity and a date of purchase of the first product;
determine a consumption rate of the first product based on the respective quantity and date of purchase; and
determine a subscription quantity and purchase frequency to match the consumption rate.

3. The electronic system of claim 1, wherein the controller is configured to cause the at least one electronic device to:
analyze the two or more POS purchase receipts to identify an average purchase price of the first product;
determine a subscription price that is less than the average purchase price of the first product indicated in the two or more POS purchase receipts; and
present the subscription price with the subscription offer.

4. The electronic system of claim 3, wherein the controller is configured to cause the at least on electronic device to:
allocate one or more cost adjustment contained in the two or more POS purchase receipts in identifying the respective purchase price; and
determine the subscription price that includes the one or more cost adjustment.

5. The electronic system of claim 4, wherein the one or more cost adjustment comprises one or more expenses from among a group comprising: (i) a sales tax; (ii) a shipping charge; (iii) a handling charge; (iv) an insurance fee; (v) use fee; (vi) government fee; (vii) a delivery charge;
(viii) a discount; and (ix) coupon.

6. The electronic system of claim 3, wherein the controller is configured to cause the at least one electronic device to:
search for matching subscription offers for the first product in more than one ecommerce service; and
determine the subscription price based on identifying at least one of the matching subscription offers that is less than the average purchase price indicated in the two or more POS purchase receipts.

7. The electronic system of claim 1, wherein the controller is configured to cause the at least one electronic device to:
receive one or more images containing the two or more purchase receipts; and
perform optical character recognition to enable analyzing of the two or more POS purchase receipts to identify the purchased one or more products.

8. The electronic system of claim 1, wherein the controller is configured to cause the at least one electronic device to:
in response to identifying unavailability of the first product for purchase via an ecommerce service:
identify availability of a second product that is a substitute for the first product; and
present, via the at least one output device, the purchase interface indicating a subscription offer for the second product.

9. The electronic system of claim 1, wherein the controller is configured to cause the at least one electronic device to:
in response to a user input indicating acceptance of the subscription offer, create and store a subscription order in accordance with the subscription offer that triggers delivery at subscription delivery date.

10. A method comprising:
analyzing, by a controller of an electronic system, two or more point of sale (POS) purchase receipts to identify a purchase of one or more items comprising a first product;
identifying availability of the first product via an ecommerce service;
determining a purchase frequency of the first product;
rendering a purchase interface indicating a subscription offer for the first product; and
modifying, via at least one output device, a display to contain the purchase interface.

11. The method of claim 10, further comprising:
identifying from analyzing the two or more POS purchase receipts, a respective quantity and a date of purchase of the first product;
determining a consumption rate of the first product based on the respective quantity and date of purchase; and
determining a subscription quantity and purchase frequency to match the consumption rate.

12. The method of claim 10, further comprising:
analyzing the two or more POS purchase receipts to identify an average purchase price of the first product;
determining a subscription price that is less than the average purchase price of the first product indicated in the two or more POS purchase receipts; and
presenting the subscription price with the subscription offer.

13. The method of claim 12, further comprising:
allocating one or more cost adjustment contained in the two or more POS purchase receipts in identifying the respective purchase price; and
determining the subscription price that includes the one or more cost adjustment.

14. The method of claim 13, wherein the one or more cost adjustment comprises one or more expenses from among a group comprising: (i) a sales tax; (ii) a shipping charge; (iii) a handling charge; (iv) an insurance fee; (v) use fee; (vi) government fee; (vii) a delivery charge; (viii) a discount; and (ix) coupon.

15. The method of claim 12, further comprising:
searching for matching subscription offers for the first product in more than one ecommerce service; and
determining the subscription price based on identifying at least one of the matching subscription offers that is less than the average purchase price indicated in the two or more POS purchase receipts.

16. The method of claim 10, further comprising:
receiving one or more images containing the two or more POS purchase receipts; and
performing optical character recognition to enable analyzing of the two or more POS purchase receipts to identify the purchased one or more products.

17. The method of claim 10, further comprising:
in response to identifying unavailability of the first product for purchase via an ecommerce service:
identifying availability of a second product that is a substitute for the first product; and
presenting, via at least one output device, the purchase interface indicating a subscription offer for the second product.

18. The method of claim 10, further comprising:
in response to a user input indicating acceptance of the subscription offer, creating and storing a subscription order in accordance with the subscription offer that triggers delivery at subscription delivery date.

19. A computer program product comprising:
a computer readable storage device; and
program code on the computer readable storage device that when executed by a processor associated with an electronic system, the program code configures the electronic system to provide functionality of:
analyzing, by a controller of the electronic system, two or more point of sale (POS) purchase receipts to identify a purchase of one or more items comprising a first product;
identifying availability of the first product via an ecommerce service;
determining a purchase frequency of the first product;
render a purchase interface indicating a subscription offer for the first product; and
modify, via at least one output device, a display to contain the purchase interface.

20. The computer program product of claim 19, where the program code configures the electronic system to provide the functionality of:
identifying from analyzing the two or more POS purchase receipts, a respective quantity and a date of purchase of the first product;
determining a consumption rate of the first product based on the respective quantity and date of purchase;
determining a subscription quantity and purchase frequency to match the consumption rate;
analyzing the two or more POS purchase receipts to identify an average purchase price of the first product;
determining a subscription price that is less than the average purchase price of the first product indicated in the two or more POS purchase receipts; and
presenting the subscription price with the subscription offer.
